(19) United States
(12) Patent Application Publication
(10) Pub. No.: US 2021/0058164 A1
(43) Pub. Date: Feb. 25, 2021

(54) METHOD FOR DATA COMMUNICATION AND POWER CHARGING USING HUMAN BODY CHANNEL, AND DEVICE FOR PERFORMING THE SAME

(71) Applicant: KOREA INSTITUTE OF SCIENCE AND TECHNOLOGY, Seoul (KR)

(72) Inventors: Yong Won SONG, Seoul (KR); Jin Seok KIM, Seoul (KR); Hyunjung YI, Seoul (KR); Minkyu JE, Daejeon (KR); Ji-Hoon SUH, Daejeon (KR); Yeseul JEON, Daejeon (KR)

(21) Appl. No.: 16/882,337

(22) Filed: May 22, 2020

(30) Foreign Application Priority Data
Aug. 22, 2019 (KR) 10-2019-0102914

(51) Int. Cl. H04B 13/00; H02J 7/00

(52) U.S. Cl. CPC H04B 13/005; H02J 7/00032

(57) ABSTRACT

A communication and charging method using a human body channel, and a device performing the communication and charging method are disclosed. The communication and charging method of an electronic device includes generating a high-frequency data signal and a low-frequency power signal by performing frequency modulation on a data signal and a power signal, and transmitting the generated high-frequency data signal and the generated low-frequency power signal to another electronic device connected to the electronic device through a human body channel.

### CROSS-REFERENCE TO RELATED APPLICATION(S)

This application claims the priority benefit of Korean Patent Application No. 10-2019-0102914 filed on Aug. 22, 2019, in the Korean Intellectual Property Office, the disclosure of which is incorporated herein by reference for all purposes.

### BACKGROUND

### 1. Field

One or more example embodiments relate to a data communication and power charging method using a human body channel, and a device for performing the data communication and power charging method.

### 2. Description of Related Art

A communication method using human body channels may refer to a technology for transmitting information to an electrode of a transmitter attached to a portion of a human body having conductivity and used as a communication channel, and restoring the transmitted information by connecting an electrode of a receiver present on the human body.

The communication method using human body channels may enable communication among various portable devices including, for example, a personal digital assistant (PDA), a portable personal computer (PC), a digital camera, an MP3 player, and a cellular phone, or enable communication between a user and a fixed device used for various purposes, for example, printing (communication with a printer), credit card payment, television (TV) reception, access control (communication with an access control system), and payment of transportation expenses when using a bus or a subway, simply through brief contact with the user.

There is ongoing research on smart wearable devices that are lightened in volume to be attachable to a human body and improved in terms of convenience. For example, for a smart lens among the smart wearable devices, research is being conducted to embody a smart lens as a device to monitor a blood sugar level of a diabetic, monitor an intraocular pressure for diagnosis of glaucoma, and realize augmented reality (AR) display.

However, when embodying such a smart lens, it may not be possible to install a battery with a sufficient capacity due to a space constraint of a physical platform and operate the smart lens for a long period of time. In addition, there may need a system operation using a wireless power charging method and a wireless communication function enabling wireless communication with an external device.

An existing data communication and wireless power charging method based on coil coupling through an electromagnetic wave may have a power transmission efficiency and a communication performance that may be degraded drastically when a transmitting coil in an external device and a receiving coil in a lens are misaligned. Thus, a user may need to continuously wear an external device that is well-aligned with the lens, or may need to position an external device close to the lens whenever the communication function operates, which may cause inconvenience.

### SUMMARY

An aspect provides a data communication and wireless charging technology using a human body channel.

The data communication and wireless charging technology may perform both body channel-based data communication and power transmission through a human body channel, thereby maximizing the convenience of a wearable device.

According to an example embodiment, there is provided a communication and charging method of an electronic device, the communication and charging method including generating a high-frequency data signal and a low-frequency power signal by performing frequency modulation on a data signal and a power signal, and transmitting the generated high-frequency data signal and the generated low-frequency power signal to another electronic device connected to the electronic device through a human body channel.

The transmitting may include transmitting a mixed signal of the high-frequency data signal and the low-frequency power signal.

The low-frequency power signal may be a low-frequency common-mode signal, and the high-frequency data signal may include a first high-frequency differential-mode data signal and a second high-frequency differential-mode data signal.

The transmitting may include transmitting a mixed signal of the low-frequency common-mode signal and the first high-frequency differential-mode data signal, and transmitting a mixed signal of the low-frequency common-mode signal and the second high-frequency differential-mode data signal.

The transmitting may include transmitting the high-frequency data signal and the low-frequency power signal by adjusting a transmission time of the high-frequency data signal and a transmission time of the low-frequency power signal to be different from each other.

According to another example embodiment, there is provided a wearable device including a signal processor configured to generate a high-frequency data signal and a low-frequency power signal by performing frequency modulation on a data signal and a power signal, and a transmitter configured to transmit the high-frequency data signal and the low-frequency power signal to another electronic device connected through a human body channel.

The transmitter may further include a mixer configured to generate a mixed signal by mixing the high-frequency data signal and the low-frequency power signal.

The low-frequency power signal may be a low-frequency common-mode signal, and the high-frequency data signal may include a first high-frequency differential-mode data signal and a second high-frequency differential-mode data signal.

The transmitter may include a first mixer configured to generate a mixed signal by mixing the low-frequency common-mode signal and the first high-frequency differential-mode data signal, and a second mixer configured to generate a mixed signal by mixing the low-frequency common-mode signal and the second high-frequency differential-mode data signal.

The transmitter may include a timing circuit configured to adjust a transmission time of the low-frequency power signal and a transmission time of the high-frequency data signal to be different from each other.

According to still another example embodiment, there is provided a communication and charging method of an electronic device, the communication and charging method including performing frequency modulation on a system control data signal based on a second frequency different from a first frequency of a first-frequency sensing data signal generated from a sensor, and generating a second-frequency system control data signal of the second frequency, and transmitting the first-frequency sensing data signal and the second-frequency system control data signal to another electronic device connected to the electronic device through a human body channel.

The transmitting may include transmitting a mixed signal of the first-frequency sensing data signal and the second-frequency system control data signal.

The transmitting may include transmitting the first-frequency sensing data signal and the second-frequency system control data signal by adjusting a transmission time of the first-frequency sensing data signal and a transmission time of the second-frequency system control data signal to be different from each other.

According to yet another example embodiment, there is provided a wearable device including a controller configured to perform frequency modulation on a system control data signal based on a second frequency that is different from a first frequency of a first-frequency sensing data signal generated from a sensor and generate a second-frequency system control data signal of the second frequency, and a transmitter configured to transmit the first-frequency sensing data signal and the second-frequency system control data signal to an electronic device connected through a human body channel.

The transmitter may include a mixer configured to generate a mixed signal by mixing the first-frequency sensing data signal and the second-frequency system control data signal.

The transmitter may include a timing circuit configured to adjust a transmission time of the first-frequency sensing data signal and a transmission time of the second-frequency system control data signal to be different from each other.

The wearable device may further include a receiver configured to receive a data signal in a form of a high-frequency signal and a power signal in a form of a low-frequency signal that are generated from the electronic device.

The receiver may include a frequency classification filtering circuit configured to filter the data signal in the form of the high-frequency signal and the power signal in the form of the low-frequency signal.

The receiver may further include a common-mode and differential-mode classifying detection circuit configured to extract the data signal and the power signal from a data signal in a form of a high-frequency differential mode-signal and a power signal in a form of a low-frequency common-mode signal.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the present disclosure will become apparent and more readily appreciated from the following description of example embodiments, taken in conjunction with the accompanying drawings of which:

FIG. 1 is a diagram illustrating an example of a communication and charging system using a human body channel according to an example embodiment;

FIG. 2 is a diagram illustrating an example of the communication and charging system illustrated in FIG. 1 that includes a wearable device and a smart lens;

FIG. 3 is a diagram illustrating an example of a communication and charging method using a human body channel to be performed by the communication and charging system illustrated in FIG. 2;

FIG. 4 is a diagram illustrating another example of the communication and charging method using a human body channel to be performed by the communication and charging system illustrated in FIG. 2;

FIG. 5 is a diagram illustrating a still another example of the communication and charging method using a human body channel to be performed by the communication and charging system illustrated in FIG. 2;

FIG. 6 is a diagram illustrating a yet another example of the communication and charging method using a human body channel to be performed by the communication and charging system illustrated in FIG. 2; and

FIG. 7 is a diagram illustrating a further another example of the communication and charging method using a human body channel to be performed by the communication and charging system illustrated in FIG. 2.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Also, in the description of embodiments, detailed description of well-known related structures or functions will be omitted when it is deemed that such description will cause ambiguous interpretation of the present disclosure.

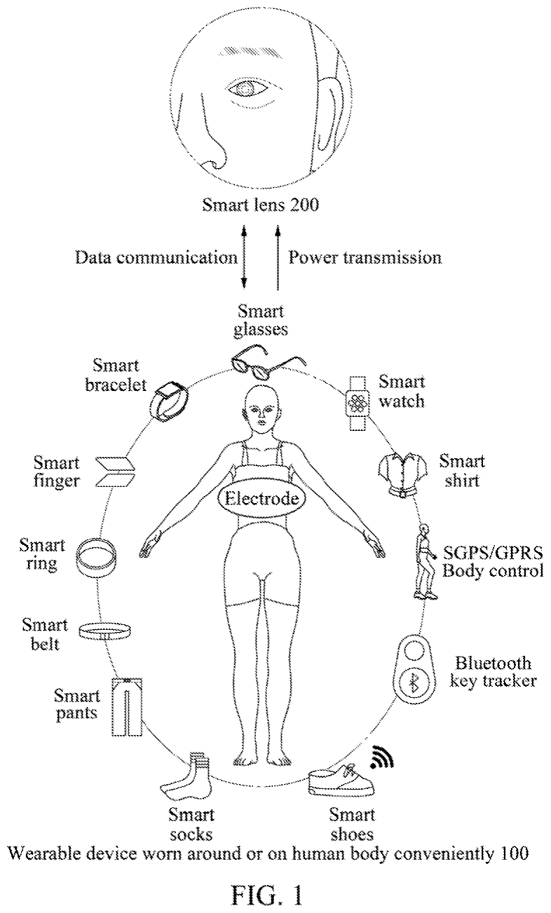

FIG. 1 is a diagram illustrating an example of a communication and charging system using a human body channel according to an example embodiment.

Referring to FIG. 1, wearable devices, for example, a wearable device 100 and a smart lens 200, may perform mutual data communication using a human body channel. One of the wearable devices 100 and 200 may transmit power to another one of the wearable devices 100 and 200. Hereinafter, the wearable devices 100 and 200 will be described as including the wearable device 100 and the smart lens 200 for the convenience of description.

The wearable devices 100 and 200 may perform mutual data communication using a human body channel, and the wearable device 100 may transmit power to the smart lens 200.

Here, data communication and wireless power charging using a human body channel may be performed by electrodes of the wearable device 100 and the smart lens 200 that are in contact with a human body. Through this, it is possible to perform the communication more conveniently and effectively, compared to a coil-coupling-based communication and charging system in which a transmitting coil and a receiving coil need to be suitably aligned.

The wearable device 100 may be embodied in various forms. The wearable device 100 may include, for example, smart glasses, a smart watch, a smart shirt, a simultaneous global positioning system (SGPS)/general packet radio service (GPRS) body control, a Bluetooth key tracker, smart shoes, smart socks, smart pants, a smart belt, a smart ring, a smart finger, and a smart bracelet.

The wearable device 100 may transmit a data signal and a power signal to the smart lens 200. For example, the wearable device 100 may control the smart lens 200 by transmitting the data signal to the smart lens 200, and charge the smart lens 200 by transmitting the power signal to the smart lens 200.

The wearable device 100 may transmit the data signal and the power signal to the smart lens 200 using at least one of a frequency division method, a common/differential mode division method, and/or a time division method.

The wearable device 100 may receive a sensing data signal and a system control data signal from the smart lens 200. For example, the wearable device 100 may receive, along with the sensing data signal, the system control data signal of which a frequency is modulated to a frequency different from a frequency of the sensing data signal, from the smart lens 200.

The wearable device 100 may filter the sensing data signal and the system control data signal that are simultaneously received from the smart lens 200, and use the sensing data signal and the system control data signal.

The smart lens 200 may receive the data signal and the power signal from the wearable device 100. For example, the smart lens 200 may simultaneously receive, from the wearable device 100, the data signal and the power signal, which are modulated to different frequencies from each other.

The smart lens 200 may filter the data signal and the power signal, which are modulated to the different frequencies, and operate based on the data signal and charge a battery or capacitor through the power signal.

The smart lens 200 may transmit the sensing data signal and the system control data signal to the wearable device 100. The sensing data signal may indicate data generated by a sensor 400 of the smart lens 200, and the system control data signal may indicate the data including, for example, a notification of completion of power reception, a request for increase or decrease of a magnitude of transmitted power, a notification of a sensor that is currently selected from among a plurality of sensors and is operating currently, a notification of a range of sensing data, and a notification of a sensing time window.

The smart lens 200 may transmit the sensing data signal and the system control data signal to the wearable device 100 using at least one of a frequency division method and/or a time division method.

In addition, the smart lens 200 may transmit, to the wearable device 100, the sensing data signal that is sensed through the sensor 400 using an analog-frequency-modulation-based transmission method. That is, such sensing data may be transmitted to the wearable device 100 through an electrode, using an output signal of an oscillation circuit of which a frequency varies based on resistance, capacitance, a current, and a voltage of the sensor. Here, to accurately read analog-frequency-modulation-based sensing data, a high-performance clock may be required. However, according to an example embodiment, the sensing data may be transmitted to the wearable device 100 and the wearable device 100 may then read the sensing data, and thus it may not need to implement such a high-performance clock in the smart lens 200.

As described above, the wearable devices, for example, the wearable device 100 and the smart lens 200, may perform data communication and wireless power charging using a human body channel. The wearable devices may concurrently perform such human-body-channel-based data communication and such human-body-channel-based power transmission, and may thus contribute to maximizing the convenience of the wearable devices.

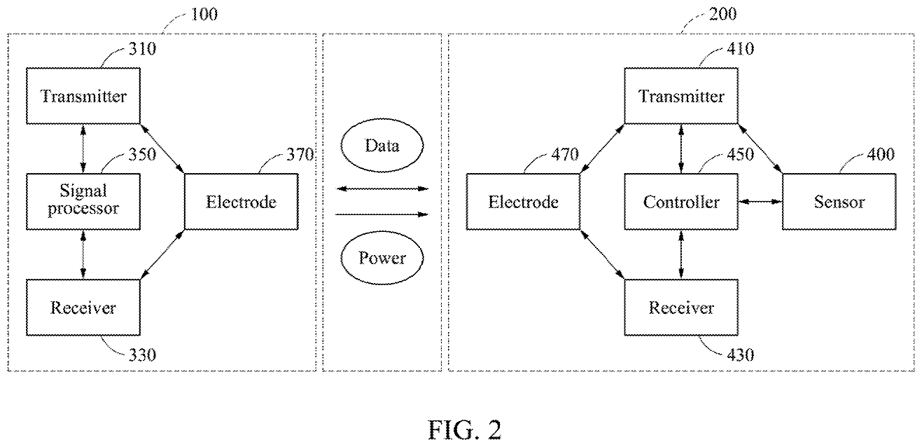

FIG. 2 is a diagram illustrating an example of the communication and charging system illustrated in FIG. 1 that includes a wearable device and a smart lens.

Referring to FIG. 2, the wearable device 100 includes a transmitter 310, a receiver 330, a signal processor 350, and an electrode 370.

The signal processor 350 may process a signal to be transmitted to the smart lens 200. For example, the signal processor 350 may modulate a frequency of a data signal to be transmitted to the smart lens 200 and a frequency of a power signal to be transmitted to the smart lens 200.

For example, the signal processor 350 may modulate the data signal to a high frequency, and the power signal to a low frequency. For another example, the signal processor 350 may generate a differential-mode signal based on such a high-frequency data signal, and a common-mode signal based on such a low-frequency power signal.

The transmitter 310 may transmit a signal processed by the signal processor 350 to the smart lens 200. For example, the transmitter 310 may transmit a mixed signal obtained by mixing the data signal and the power signal of which the respective frequencies are modulated by the signal processor 350, or transmit the data signal and the power signal by adjusting respective transmission times thereof to be different from each other.

The receiver 330 may receive a signal from the smart lens 200. For example, the receiver 330 may receive a sensing data signal and a system control data signal from the smart lens 200.

In addition, the receiver 330 may filter the sensing data signal and the system control data signal.

The smart lens 200 includes the sensor 400, a transmitter 410, a receiver 430, a controller 450, and an electrode 470.

The controller 450 may generate a signal to be transmitted to the wearable device 100. For example, the controller 450 may modulate a frequency of the system control data signal. In this example, the controller 450 may modulate the frequency of the system control data signal to a frequency different from that of the sensing data signal generated from the sensor 400.

The transmitter 410 may transmit, to the wearable device 100, the sensing data signal and/or a signal processed by the controller 450. For example, the transmitter 410 may transmit, to the wearable device 100, a mixed signal obtained by mixing the sensing data signal and the system control data signal of which the frequency is modulated by the controller 450, or transmit, to the wearable device 100, the sensing data signal and the system control data signal by adjusting respective transmission times of the sensing data signal and the system control data signal to be different from each other.

The receiver 430 may receive a signal from the wearable device 100. For example, the receiver 430 may receive the data signal and the power signal from the wearable device 100.

In addition, the receiver 430 may filter the data signal and the power signal.

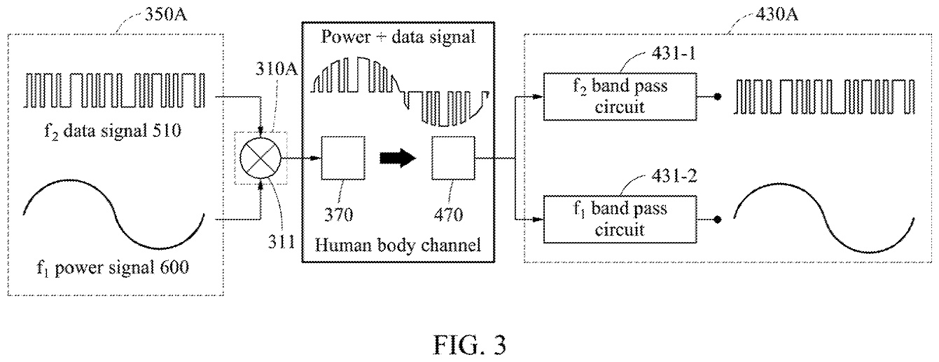

Hereinafter, examples of a data communication and power transmission method using a human body channel between the smart lens 200 and the wearable device 100 configured to perform data communication and power transmission with the smart lens 200 will be described in detail with reference to FIGS. 3 through 7.

FIG. 3 is a diagram illustrating an example of a communication and charging method using a human body channel to be performed by the communication and charging system illustrated in FIG. 2.

Referring to FIG. 3, a signal processor 350A, a transmitter 310A, and a receiver 430A illustrated in FIG. 3 may be respective examples of the signal processor 350, the transmitter 310, and the receiver 430 described above with reference to FIG. 2. The electrodes 370 and 470 may be connected through a human body channel, and the wearable device 100 and the smart lens 200 may transmit and receive data and power through the electrodes 370 and 470. The electrode 370 may be included in the wearable device 100, and the electrode 470 may be included in the smart lens 200.

The wearable device 100 may mix a high-frequency f₂ data signal 510 and a low-frequency f₁ power signal 600, and transmit a mixed signal of the high-frequency f₂ data signal 510 and the low-frequency f₁ power signal 600 to the smart lens 200. Thus, the wearable device 100 may simultaneously transmit a data signal and a power signal to the smart lens 200, and thus a circuit structure of the receiver 430A of the smart lens 200 may be more simplified.

The signal processor 350A may generate the high-frequency f₂ data signal 510 by performing frequency modulation on the data signal and generate the low-frequency f₁ power signal 600 by performing frequency modulation on the power signal. The transmitter 310A includes a mixer 311 configured to generate the mixed signal.

The transmitter 310A may transmit, to the smart lens 200, the mixed signal obtained by the mixer 311 by mixing the signals processed by the signal processor 350A.

For example, the transmitter 310A may mix the high-frequency f₂ data signal 510 and the low-frequency f₁ power signal 600 using the mixer 311 and transmit the mixed signal to the smart lens 200 through the electrode 370. Thus, the wearable device 100 may simultaneously transmit the data signal and the power signal to the smart lens 200 using a human body channel.

The smart lens 200 may receive the mixed signal from the wearable device 100 and filter the mixed signal to obtain the high-frequency f₂ data signal 510 and the low-frequency f₁ power signal 600 from the mixed signal.

The receiver 430A may receive the mixed signal of the high-frequency f₂ data signal 510 and the low-frequency f₁ power signal 600 through the electrode 470.

The receiver 430A includes frequency classification filtering circuits 431-1 and 431-2. For example, the frequency classification filtering circuits 431-1 and 431-2 include a f₂ band-pass circuit 431-1 and a fᵢ band-pass circuit 431-2 as illustrated.

The f₂ band-pass circuit 431-1 may filter the mixed signal to output the high-frequency f₂ data signal 510, and the f₁ band-pass circuit 431-2 filter the mixed signal to output the low-frequency f₁ power signal 600.

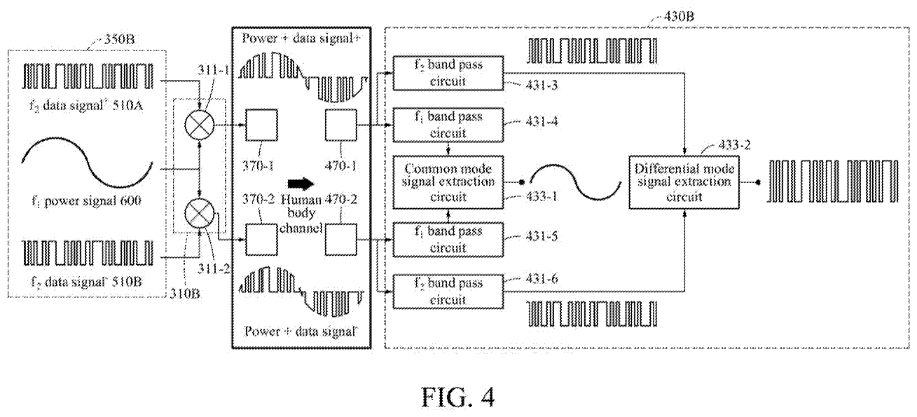

FIG. 4 is a diagram illustrating another example of the communication and charging method using a human body channel to be performed by the communication and charging system illustrated in FIG. 2.

Referring to FIG. 4, a signal processor 350B, a transmitter 310B, and a receiver 430B illustrated in FIG. 4 may be respective examples of the signal processor 350, the transmitter 310, and the receiver 430 described above with reference to FIG. 2. Electrodes 370-1, 370-2, 470-1, and 470-2 illustrated in FIG. 4 may be connected through a human body channel, and the wearable device 100 and the smart lens 200 may communicate with each other through the electrodes 370-1, 370-2, 470-1, and 470-2. The electrodes 370-1 and 370-2 may be included in the wearable device 100, and the electrodes 470-1 and 470-2 may be included in the smart lens 200.

The wearable device 100 may simultaneously transmit, to the smart lens 200, mixed signals obtained based on a first high-frequency f₂ differential-mode data signal 510A, a second high-frequency f₂ differential-mode data signal 510B, and a low-frequency f₁ common-mode signal 600. Through this, it is possible to improve performance in classifying or distinguishing a power signal and a data signal.

The signal processor 350B may modulate a frequency of a data signal and a frequency of a power signal, and generate a differential-mode signal and a common-mode signal. For example, the signal processor 350B may modulate the data signal to a high-frequency f₂ data signal, and generate the first high-frequency f₂ differential-mode data signal 510A and the second high-frequency f₂ differential-mode data signal 510B based on the high-frequency f₂ data signal. In addition, the signal processor 350B may modulate the power signal to a low-frequency f₁ power signal, and generate the low-frequency f₁ common-mode signal 600.

The transmitter 310B includes a first mixer 311-1 and a second mixer 311-2 to generate the mixed signals.

The first mixer 311-1 may transmit, to the smart lens 200 through the electrode 370-1, a first mixed signal obtained by mixing the first high-frequency f₂ differential-mode data signal 510A and the low-frequency f₁ common-mode signal 600. The second mixer 311-2 may transmit, to the smart lens 200 through the electrode 370-2, a second mixed signal obtained by mixing the second high-frequency f₂ differential-mode data signal 510B and the low-frequency f₁ common-mode signal 600. Thus, the wearable device 100 may transmit the data signal and the power signal to the smart lens 200, with an improved level of performance in classifying or distinguishing the data signal and the power signal.

The receiver 430B of the smart lens 200 may simultaneously receive the data signal and the power signal from the wearable device 100 through the electrodes 470-1 and 470-2.

The receiver 430 includes frequency classification filtering circuits 413-3 through 413-6, and extraction circuits 433-1 and 433-2. For example, the extraction circuits 433-1 and 433-2 include a common-mode signal extraction circuit 433-1 and a differential-mode signal extraction circuit 433-2. The frequency classification filtering circuits 431-3 through 431-6 include f₁ band-pass circuits 431-4 and 431-5, and f₂ band-pass circuits 431-3 and 431-6.

The f₁ band-pass circuit 431-4 may filter the first mixed signal to obtain the low-frequency f₁ common-mode signal 600 from the first mixed signal, and output the obtained low-frequency f₁ common-mode signal 600 to the common-mode signal extraction circuit 433-1.

The f₂ band-pass circuit 431-3 may filter the first mixed signal to obtain the first high-frequency f₂ differential-mode data signal 510A from the first mixed signal, and output the obtained first high-frequency f₂ differential-mode data signal 510A to the differential-mode signal extraction circuit 433-2.

The f₁ band-pass circuit 431-5 may filter the second mixed signal to obtain the low-frequency f₁ common-mode signal 600 from the second mixed signal, and output the obtained low-frequency f₁ common-mode signal 600 to the common-mode signal extraction circuit 433-1.

The f₂ band-pass circuit 431-6 may filter the second mixed signal to obtain the second high-frequency f₂ differential-mode data signal 510B from the second mixed signal, and output the obtained second high-frequency f₂ differential-mode data signal 510B to the differential-mode signal extraction circuit 433-2.

The common-mode signal extraction circuit 433-1 may generate or extract the low-frequency f₁ power signal using the low-frequency f₁ common-mode signal 600 obtained from the first mixed signal through the filtering and the low-frequency f₁ common-mode signal 600 obtained from the second mixed signal through the filtering.

The differential-mode signal extraction circuit 433-2 may generate or extract the high-frequency f₂ data signal using the first high-frequency f₂ differential-mode data signal 510A obtained from the first mixed signal through the filtering and the second high-frequency f₂ differential-mode data signal 510B obtained from the second mixed signal through the filtering.

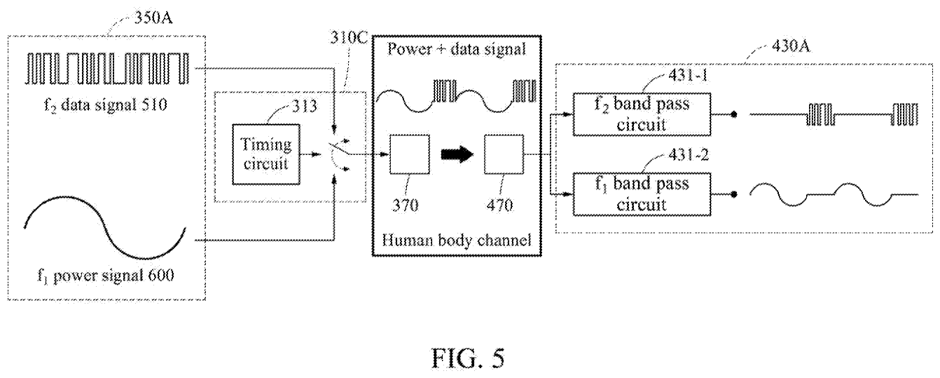

FIG. 5 is a diagram illustrating a still another example of the communication and charging method using a human body channel to be performed by the communication and charging system illustrated in FIG. 2.

Referring to FIG. 5, a signal processor 350A and a receiver 430A illustrated in FIG. 5 may be the same as the signal processor 350A and the receiver 430A described above with reference to FIG. 3, and a transmitter 310C illustrated in FIG. 5 may be respective examples of the transmitter 310 and described above with reference to FIG. 2.

The wearable device 100 may adjust a transmission time of a high-frequency f₂ data signal 510 and a transmission time of a low-frequency f₁ power signal 600 to be different from each other, and transmit them to the smart lens 200 through the electrode 370. Through this, it is possible to improve a level of performance in classifying or distinguishing the high-frequency f₂ data signal 510 and the low-frequency f₁ power signal 600, and simplify a circuit structure of the receiver 430A of the smart lens 200.

The transmitter 310C includes a timing circuit 313 configured to adjust a transmission time of a signal. For example, the timing circuit 313 may adjust the transmission time of the high-frequency f₂ data signal 510 and the transmission time of the low-frequency f₁ power signal 600 to be different from each other, and transmit the high-frequency f₂ data signal 510 and the low-frequency f₁ power signal 600 to the smart lens 200.

The receiver 430A of the smart lens 200 may receive, from the wearable device 100 through the electrode 470, the high-frequency f₂ data signal 510 and the low-frequency f₁ power signal 600 for which the respective transmission times are adjusted.

The receiver 430A includes frequency classification filtering circuits 431-1 and 431-2. For example, the frequency classification filtering circuits 431-1 and 431-2 include a f₂ band-pass circuit 431-1 and a fᵢ band-pass circuit 431-2.

The f₂ band-pass circuit 431-1 may output the high-frequency f₂ data signal 510 by filtering the signal for which the transmission time is adjusted, and the f₁ band-pass circuit 431-2 may output the low-frequency f₁ power signal 600 by filtering the signal for which the transmission time is adjusted.

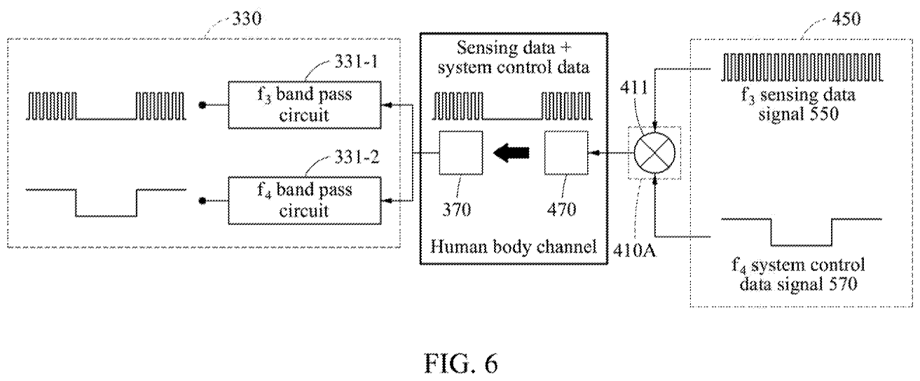

FIG. 6 is a diagram illustrating a yet another example of the communication and charging method using a human body channel to be performed by the communication and charging system illustrated in FIG. 2.

Referring to FIG. 6, a controller 450, a transmitter 410A, and a receiver 330 illustrated in FIG. 6 may be respective examples of the controller 450, the transmitter 410, and the receiver 330 described above with reference to FIG. 2.

The smart lens 200 may mix a first-frequency f₃ sensing data signal 550 and a second-frequency f₄ system control data signal 570, and transmit a mixed signal of the first-frequency f₃ sensing data signal 550 and the second-frequency f₄ system control data signal 570 to the wearable device 100. Thus, the smart lens 200 may simultaneously transmit the first-frequency f₃ sensing data signal 550 and the second-frequency f₄ system control data signal 570 to the wearable device 100.

The controller 450 may generate the second-frequency f₄ system control data signal 570 by modulating a system control data signal to a second frequency f₄ different from a first frequency f₃ of the first-frequency f₃ sensing data signal 550.

The transmitter 410A includes a mixer 411 configured to generate the mixed signal. The transmitter 410A may transmit, to the wearable device 100, the mixed signal obtained by the mixer 411 by mixing the first-frequency f₃ sensing data signal 550 and the second-frequency f₄ system control data signal 570 generated by the controller 450.

For example, the mixer 411 may mix the first-frequency f₃ sensing data signal 550 and the second-frequency f₄ system control data signal 570, and transmit the mixed signal to the wearable device 100 through the electrode 470. Thus, the smart lens 200 may simultaneously transmit a sensing data signal and a system control data signal to the wearable device 100 using a human body channel.

The wearable device 100 may receive the mixed signal from the smart lens 200, and obtain the first-frequency f₃ sensing data signal 550 and the second-frequency f₄ system control data signal 570 from the received mixed signal through filtering.

The receiver 330 may receive the mixed signal of the first-frequency f₃ sensing data signal 550 and the second-frequency f₄ system control data signal 570 through the electrode 370.

The receiver 330 includes frequency classification filtering circuits 331-1 and 331-2. For example, the frequency classification filtering circuits 331-1 and 331-2 include a f₃ band-pass circuit 331-1 and a f₄ band-pass circuit 331-2.

The f₃ band-pass circuit 331-1 may output the first-frequency f₃ sensing data signal 550 by filtering the mixed signal, and the f₄ band-pass circuit 331-2 may output the second-frequency f₄ system control data signal 570 by filtering the mixed signal.

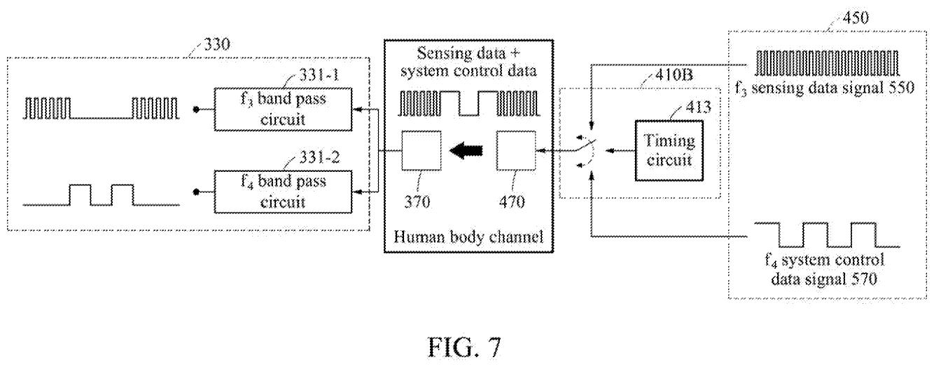

FIG. 7 is a diagram illustrating a further another example of the communication and charging method using a human body channel to be performed by the communication and charging system illustrated in FIG. 2.

Referring to FIG. 7, a controller 450 and a receiver 330 illustrated in FIG. 7 may be the same as the controller 450 and the receiver 330 described above with reference to FIG. 6, and a transmitter 410B illustrated in FIG. 7 may be another example of the transmitter 410 described above with reference to FIG. 2.

The smart lens 200 may adjust a transmission time of a first-frequency f₃ sensing data signal 550 and a transmission time of a second-frequency f₄ system control data signal 570 to be different from each other, and transmit the first-frequency f₃ sensing data signal 550 and the second-frequency f₄ system control data signal 570 to the smart lens 200 through the electrode 370 at the differently adjusted transmission times. Through this, it is possible to improve a level of performance in classifying or distinguishing the first-frequency f₃ sensing data signal 550 and the second-frequency f₄ system control data signal 570.

The transmitter 410B includes a timing circuit 413 configured to adjust a transmission time of a signal. For example, the timing circuit 413 may adjust the transmission time of the first-frequency f₃ sensing data signal 550 and the transmission time of the second-frequency f₄ system control data signal 570 generated by the controller 450 to be different from each other, and transmit them to the wearable device 100 at the adjusted transmission times.

The receiver 330 may receive, from the smart lens 200 through the electrode 370, the first-frequency f₃ sensing data signal 550 and the second-frequency f₄ system control data signal 570 for which the respective transmission times are adjusted.

The f₃ band pass-circuit 331-1 may output the first-frequency f₃ sensing data signal 550 by filtering the signal for which the transmission time is adjusted, and the f₄ band-pass circuit 331-2 may output the second-frequency f₄ system control data signal 570 by filtering the signal for which the transmission time is adjusted.

The units described herein may be implemented using hardware components and software components. For example, the hardware components may include electrodes, amplifiers, band-pass filters, analog-to-digital convertors, non-transitory computer memory and processing devices. A processing device may be implemented using one or more general-purpose or special-purpose computers, such as, for example, a processor, a controller and an arithmetic logic unit (ALU), a digital signal processor, a microcomputer, a field-programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums. The non-transitory computer readable recording medium may include any data storage device that can store data which can be thereafter read by a computer system or processing device.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A communication and charging method of an electronic device, comprising:
generating a high-frequency data signal and a low-frequency power signal by performing frequency modulation on a data signal and a power signal; and
transmitting the generated high-frequency data signal and the generated low-frequency power signal to another electronic device connected to the electronic device through a human body channel.

2. The communication and charging method of claim 1, wherein the transmitting comprises:
transmitting a mixed signal of the high-frequency data signal and the low-frequency power signal.

3. The communication and charging method of claim 1, wherein the low-frequency power signal is a low-frequency common-mode signal, and
the high-frequency data signal comprises a first high-frequency differential-mode data signal and a second high-frequency differential-mode data signal.

4. The communication and charging method of claim 3, wherein the transmitting comprises:
transmitting a mixed signal of the low-frequency common-mode signal and the first high-frequency differential-mode data signal; and
transmitting a mixed signal of the low-frequency common-mode signal and the second high-frequency differential-mode data signal.

5. The communication and charging method of claim 1, wherein the transmitting comprises:
transmitting the high-frequency data signal and the low-frequency power signal by adjusting a transmission time of the high-frequency data signal and a transmission time of the low-frequency power signal to be different from each other.

6. A wearable device comprising:
a signal processor configured to generate a high-frequency data signal and a low-frequency power signal by performing frequency modulation on a data signal and a power signal; and
a transmitter configured to transmit the high-frequency data signal and the low-frequency power signal to another electronic device connected through a human body channel.

7. The wearable device of claim 6, wherein the transmitter further comprises:
a mixer configured to generate a mixed signal by mixing the high-frequency data signal and the low-frequency power signal.

8. The wearable device of claim 6, wherein the low-frequency power signal is a low-frequency common-mode signal, and
the high-frequency data signal comprises a first high-frequency differential-mode data signal and a second high-frequency differential-mode data signal.

9. The wearable device of claim 8, wherein the transmitter comprises:
a first mixer configured to generate a mixed signal by mixing the low-frequency common-mode signal and the first high-frequency differential-mode data signal; and
a second mixer configured to generate a mixed signal by mixing the low-frequency common-mode signal and the second high-frequency differential-mode data signal.

10. The wearable device of claim 6, wherein the transmitter comprises:
a timing circuit configured to adjust a transmission time of the low-frequency power signal and a transmission time of the high-frequency data signal to be different from each other.

11. A communication and charging method of an electronic device, comprising:
performing frequency modulation on a system control data signal based on a second frequency different from a first frequency of a first-frequency sensing data signal generated from a sensor, and generating a second-frequency system control data signal of the second frequency; and
transmitting the first-frequency sensing data signal and the second-frequency system control data signal to another electronic device connected to the electronic device through a human body channel.

12. The communication and charging method of claim 11, wherein the transmitting comprises:
transmitting a mixed signal of the first-frequency sensing data signal and the second-frequency system control data signal.

13. The communication and charging method of claim 11, wherein the transmitting comprises:
transmitting the first-frequency sensing data signal and the second-frequency system control data signal by adjusting a transmission time of the first-frequency sensing data signal and a transmission time of the second-frequency system control data signal to be different from each other.

14. A wearable device comprising:
a controller configured to perform frequency modulation on a system control data signal based on a second frequency different from a first frequency of a first-frequency sensing data signal generated from a sensor, and generate a second-frequency system control data signal of the second frequency; and
a transmitter configured to transmit the first-frequency sensing data signal and the second-frequency system control data signal to an electronic device connected through a human body channel.

15. The wearable device of claim 14, wherein the transmitter comprises:
a mixer configured to generate a mixed signal by mixing the first-frequency sensing data signal and the second-frequency system control data signal.

16. The wearable device of claim 14, wherein the transmitter comprises:
a timing circuit configured to adjust a transmission time of the first-frequency sensing data signal and a transmission time of the second-frequency system control data signal to be different from each other.

17. The wearable device of claim 14, further comprising:
a receiver configured to receive a data signal in a form of a high-frequency signal and a power signal in a form of a low-frequency signal that are generated from the electronic device.

18. The wearable device of claim 17, wherein the receiver comprises:
a frequency classification filtering circuit configured to filter the data signal in the form of the high-frequency signal and the power signal in the form of the low-frequency signal.

19. The wearable device of claim 17, wherein the receiver further comprises:
a common-mode and differential-mode classifying detection circuit configured to extract the data signal and the power signal from a data signal in a form of a high-frequency differential-mode signal and a power signal in a form of a low-frequency common-mode signal.
